(19) United States
(12) Patent Application Publication
(10) Pub. No.: US 2013/0157136 A1
(43) Pub. Date: Jun. 20, 2013

(54) COATING OF DISORDERED CARBON ACTIVE MATERIAL USING WATER-BASED BINDER SLURRY

(71) Applicant: Mark Balicki, Fishers, IN (US)

(72) Inventor: Mark Balicki, Fishers, IN (US)

(73) Assignee: ENERDEL, INC., Indianapolis, IN (US)

(21) Appl. No.: 13/327,353

(22) Filed: Dec. 15, 2011

(51) Int. Cl. H01M 4/583; H01M 4/26; H01M 10/04; H01M 4/525

(52) U.S. Cl. 429/223; 429/231.8; 29/623.5; 432/18; 252/182.1

(57) ABSTRACT

An electrochemical cell manufactured by coating a conductive substrate of an electrode with a disordered carbon active material using a water-based binder slurry. An exemplary binder slurry includes at least one disordered carbon material, carboxymethyl cellulose (CMC), styrene butadiene rubber (SBR), and water.

### FIELD OF THE DISCLOSURE

The present disclosure relates to manufacturing an electrochemical cell and, more particularly, to manufacturing an electrochemical cell by coating a conductive substrate of an electrode with a disordered carbon active material using a water-based binder slurry.

### BACKGROUND OF THE DISCLOSURE

Lithium-based electrochemical cells include a negative electrode (or anode), a positive electrode (or cathode), and an electrolyte therebetween. In use, lithium ions travel between the negative and positive electrodes to generate power.

Each electrode includes a first, active layer bound to a second, conductive layer. Graphite is a known active material for use in lithium-based electrochemical cells, specifically on the negative electrodes of lithium-based electrochemical cells. With graphite as the active material, a water-based (i.e., aqueous) binder slurry may be used to bind the active layer to the underlying conductive layer.

Disordered, non-graphitic carbon materials, such as hard carbon and soft carbon, have certain performance advantages over graphite materials, including longer life and better rate performance. However, because such disordered carbon materials tend to deteriorate when exposed to oxygen and water in the atmosphere, it was believed that the water-based binder slurries used to bind ordered graphite active materials would not be suitable to bind disordered carbon active materials. Thus, organic binder slurries have traditionally been used with disordered carbon active materials.

### SUMMARY OF THE DISCLOSURE

The present disclosure relates to manufacturing an electrochemical cell by coating a conductive substrate of an electrode with a disordered carbon active material using a water-based binder slurry. An exemplary binder slurry includes at least one disordered carbon material, carboxymethyl cellulose (CMC), styrene butadiene rubber (SBR), and water.

According to an embodiment of the present disclosure, a water-based binder slurry is provided to produce an electrode of an electrochemical cell, the binder slurry including at least one disordered carbon material, at least one binder, and water.

According to another embodiment of the present disclosure, an electrochemical cell is provided including a cathode, an anode, and an electrolyte in communication with the anode and the cathode. The cathode includes an active layer and a conductive layer. The anode includes an active layer with at least one disordered carbon material and a conductive layer, the at least one disordered carbon material in the active layer of the anode being adhered to the conductive layer of the anode using a binder slurry that includes CMC, SBR, and water.

According to yet another embodiment of the present disclosure, a method is provided for manufacturing an electrochemical cell. The method includes the steps of: preparing a binder slurry including: at least one disordered carbon material, CMC, SBR, and water; applying the binder slurry to a conductive substrate to form an anode; and placing the anode in electrical communication with a cathode.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a schematic view of a lithium-based electrochemical cell having a negative electrode and a positive electrode;

FIG. 2A is a schematic view of a disordered, hard carbon material for use on the negative electrode of FIG. 1;

FIG. 2B is a schematic view of a disordered, soft carbon material for use on the negative electrode of FIG. 1;

FIGS. 3-7 are graphs showing performance test results for hard carbon cells made with a first water-based binder slurry;

FIGS. 8A-17 are graphs showing performance test results for hard carbon cells made with a second water-based binder slurry, the second water-based binder slurry being coated on different days;

FIGS. 18 and 19 are graphs showing performance test results for hard carbon cells made with a third water-based binder slurry;

FIGS. 20-29 are graphs showing additional performance test results for hard carbon cells made with the second water-based binder slurry; and

FIG. 30 is a flow chart showing an exemplary method for preparing and applying a water-based binder slurry.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE DRAWINGS

The embodiments disclosed herein are not intended to be exhaustive or to limit the invention to the precise forms disclosed in the following detailed description. Rather, the embodiments are chosen and described so that others skilled in the art may utilize their teachings.

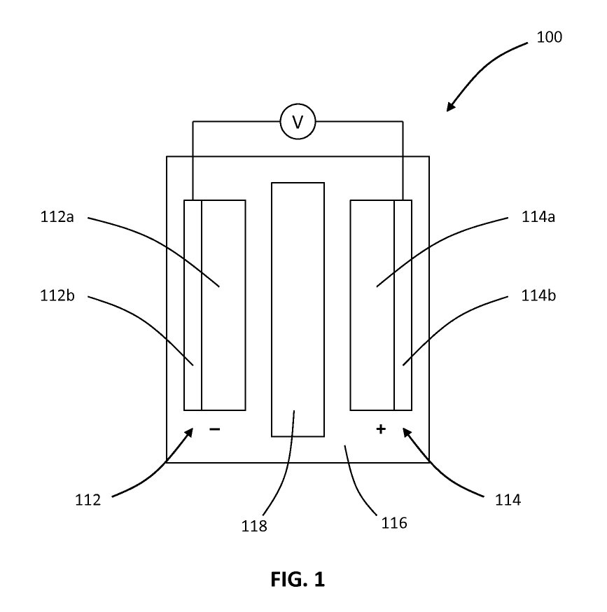

FIG. 1 provides a lithium-based electrochemical cell 100 which may be used in rechargeable and non-rechargeable batteries. Cell 100 may be used in a rechargeable battery of a hybrid vehicle or an electric vehicle, for example, serving as a power source that drives an electric motor of the vehicle. Cell 100 may also store and provide energy to other devices which receive power from batteries, such as the stationary energy storage market. Exemplary applications for the stationary energy storage market include providing power to a power grid, providing power as an uninterrupted power supply, and other loads which may utilize a stationary power source. In one embodiment, cell 100 may be implemented to provide an uninterrupted power supply for computing devices and other equipment in data centers. A controller of the data center or other load may switch from a main power source to an energy storage system of the present disclosure based on one or more characteristics of the power being received from the main power source or a lack of sufficient power from the main power source.

Cell 100 of FIG. 1 includes a negative electrode (or anode) 112 and a positive electrode (or cathode) 114. Between negative electrode 112 and positive electrode 114, cell 100 of FIG. 1 also contains electrolyte 116 and separator 118. When discharging cell 100, lithium ions travel through electrolyte 116 from negative electrode 112 to positive electrode 114, with electrons flowing in the same direction from negative electrode 112 to positive electrode 114 and current flowing in the opposite direction from positive electrode 114 to negative electrode 112, according to conventional current flow terminology. When charging cell 100, an external power source forces reversal of the current flow from negative electrode 112 to positive electrode 114.

Negative electrode 112 of cell 100 illustratively includes a first layer 112a of an active material that interacts with lithium ions in electrolyte 116 and an underlying substrate or second layer 112b of a conductive material, as shown in FIG. 1. The first, active layer 112a may be applied to one or both sides of the second, conductive layer 112b. Per unit area (1 cm²) of the conductive layer 112b, an exemplary active layer 112a is applied to each side of the conductive layer 112b at more than about 5 mg/cm², on average. In an exemplary embodiment, the active layer 112a is applied to each side of the conductive layer 112b at an average load weight per unit area (i.e., load density) between about 6 mg/cm² and 14 mg/cm², more specifically between about 8 mg/cm² and 12 mg/cm², and even more specifically about 10 mg/cm². According to this exemplary embodiment, a negative electrode 112 having a double-sided active layer 112a would have an average load weight per unit area between about 12 mg/cm² and 28 mg/cm², more specifically between about 16 mg/cm² and 24 mg/cm², and even more specifically about 20 mg/cm². To achieve such load weights, active layer 112a may be applied to each side of the conductive layer 112b at thicknesses of about 50 μm, 100 μm, 150 μm, 200 μm, or more. Exemplary active materials for the first layer 112a of negative electrode 112 include, for example, disordered carbon materials, which are discussed further below. Exemplary conductive materials for the second layer 112b of negative electrode 112 include metals and metal alloys, such as aluminum, copper, nickel, titanium, and stainless steel. The second, conductive layer 112b of negative electrode 112 may be in the form of a thin foil sheet or a mesh, for example. An exemplary conductive layer 112b has a thickness of about 10 μm.

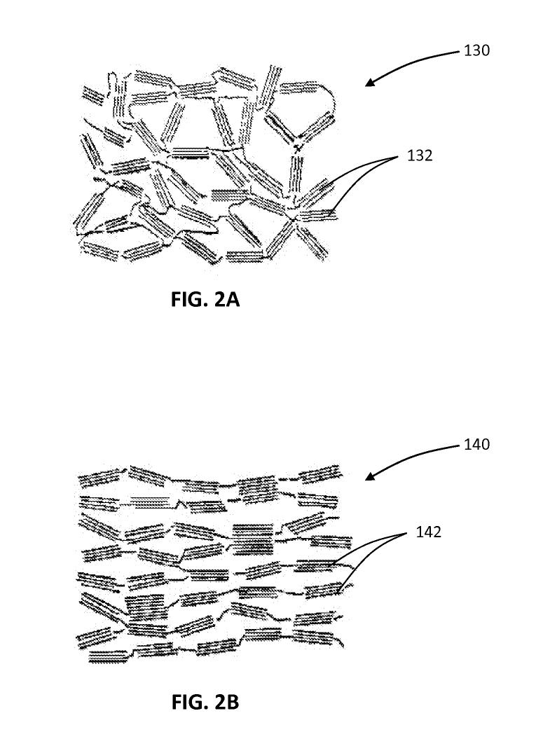

In one exemplary embodiment, the first, active layer 112a of negative electrode 112 (FIG. 1) includes a disordered, non-graphitic, non-crystalline, hard carbon material 130. As shown in FIG. 2A, hard carbon 130 includes a plurality of disordered, unevenly spaced graphene sheets 132 of varied shapes and sizes, with adjacent graphene sheets 132 being spaced apart by about 0.38 nm or more to receive lithium ions therebetween. The disordered, uneven spacing of graphene sheets 132 is shown in FIG. 2A, for example, with some graphene sheets 132 being oriented generally horizontally and other graphene sheets 132 being oriented generally vertically. Hard carbon materials 130 are generally made from organic precursors that char as they pyrolyze.

In another exemplary embodiment, the first, active layer 112a of negative electrode 112 (FIG. 1) includes a disordered, non-graphitic, non-crystalline, soft carbon material 140. As shown in FIG. 2B, soft carbon 140 includes a plurality of stacked, unevenly spaced graphene sheets 142 of varied shapes and sizes, with adjacent graphene sheets 142 being spaced apart by about 0.375 nm or more to receive lithium ions therebetween. Compared to graphene sheets 132 of hard carbon 130 (FIG. 2A), graphene sheets 142 of soft carbon 140 (FIG. 2B) are more closely aligned for more even stacking Soft carbon materials 140 are generally made from organic precursors that melt before they pyrolyze.

Disordered carbon electrodes, such as electrodes made of hard carbon 130 (FIG. 2A) or soft carbon 140 (FIG. 2B), may be capable of having higher capacities than ordered carbon electrodes. For example, while adjacent graphene sheets (not shown) of graphite may be required to fluctuate in spacing to accommodate lithium ions, adjacent graphene sheets 132 of hard carbon 130 (FIG. 2A) and adjacent graphene sheets 142 of soft carbon 140 (FIG. 2B) may be sufficiently spaced apart (e.g., spaced apart by more than about 0.34 nm, 0.35 nm, 0.36 nm, 0.37 nm, 0.38 nm, 0.39 nm, or 0.40 nm) to accommodate lithium ions without fluctuating in spacing.

Because disordered carbon materials tend to deteriorate when exposed to oxygen and water in the atmosphere, it was anticipated that using a water-based binder slurry to coat a disordered carbon active material 112a onto the underlying conductive layer 112b of negative electrode 112 (FIG. 1) would hinder or preclude operation of cell 100. However, the present inventor discovered the opposite result—cells 100 exhibited satisfactory performance when water-based binder slurries were used to apply disordered carbon active materials 112a of negative electrode 112.

An exemplary water-based binder slurry includes the desired disordered carbon active material and a suitable binder, where the disordered carbon active material and the binder are dissolved in distilled water. The binder may include more than one ingredient, such as carboxymethyl cellulose (CMC) and styrene butadiene rubber (SBR). In one exemplary embodiment, for example, the water-based binder slurry includes about 96 wt. % hard carbon active material, about 2 wt. % CMC, and about 2 wt. % SBR dissolved in distilled water. In this embodiment, the binder slurry does not require active carbon. Together, the hard carbon, CMC, and SBR may make up about 40 wt. %, 50 wt. %, or 60 wt. % of the binder slurry, for example, with the distilled water making up the balance.

Organic binder slurries require special organic solvents like N-methylpyrrolidone (NMP), while water-based binder slurries use distilled water as the solvent. Advantageously, water is less expensive and more readily available than such organic solvents. Also, water is more environmentally friendly and generally easier to store and dispose of than are such organic solvents. For example, some organic solvents react in the presence of water and must be carefully stored in air-tight conditions.

Referring next to FIG. 30, some of the steps in an exemplary method 200 are provided for preparing and applying the water-based binder slurry of the present disclosure.

First, in step 202, the ingredients (e.g., the disordered carbon active material, CMC, SBR, and distilled water) are placed together in a mixer, such as a planetary mixer. Then, the ingredients are mixed for about 1 hour or more.

Optionally, after the mixing step 202, the binder slurry is stored in step 204. This optional storing step 204 may last for several hours or several days, for example. However, the binder slurry may begin to harden and/or separate when left alone without agitation during the storing step 204. Mixing the binder slurry again, such as for about 30 minutes, may return the binder slurry to its original form. It may also be necessary to add more water solvent to the binder slurry. Limiting exposure to oxygen during the storing step 204, such as by storing the binder slurry under seal or vacuum, may reduce such hardening and/or separating. Also, limiting the storage time by performing the mixing step 202 as close as possible to the coating step 206 (discussed below) will reduce, and potentially avoid, such hardening and/or separating.

At this stage, the water-based binder slurry should have a viscosity at room temperature between about 4,000 cP and 6,000 cP, more specifically between about 4,500 cP and 5,500 cP, and even more specifically about 5,000 cP. The viscosity may be measured using, for example, a suitable rotational viscometer at various rotational speeds, such as about 10 rpm, 20 rpm, 50 rpm, and 100 rpm. To increase the viscosity, if necessary, the binder slurry may be left to rest to partially solidify. To decrease the viscosity, if necessary, additional solvent may be added to the binder slurry followed by additional mixing. Decreasing the viscosity of the binder slurry may become necessary after the storing step 204, for example.

Next, in step 206 of method 200, the binder slurry is sprayed, spread, or otherwise coated onto the conductive substrate 112b. In a continuous coating step 206, the conductive substrate 112b is conveyed continuously from a roll of material across a sprayer. The conductive substrate 112b may be cut to shape after the steps of method 200 discussed herein. It is also within the scope of the present disclosure that the coating step 206 may be a batch process, with each conductive substrate 112b being cut to shape and coated individually.

After the coating step 206, the coated material is partially dried by subjecting negative electrode 112 to a first drying step 208. In an exemplary embodiment, the first drying step 208 is performed by conveying negative electrode 112 through a vacuum furnace that is heated to a moderate temperature of about 60° C., 65° C., 70° C., or less. The first drying step 208 may encourage even drying of the water-based binder slurry with limited or no cracking Without wishing to be bound by theory, the present inventor believes that the water-based binder slurries of the present disclosure are more susceptible to cracking than organic binder slurries, particularly due to the high-molecular-weight CMC molecules in water-based binder slurries that may become oriented in rows and develop cracks therebetween. Thus, although organic binder slurries may be subjected to initial drying at temperatures of about 80° C., 90° C., or more without cracking, an exemplary first drying step 208 of the present disclosure dries the water-based binder slurries at lower temperatures, such as about 60° C., 65° C., 70° C., or less.

To form a double-sided active layer 112a on negative electrode 112, the substrate 112b may be flipped upside down to expose the uncoated side. Then, the coating step 206 and the first drying step 208 may be repeated on the uncoated side.

Next, in step 210 of method 200, the active layer 112a of negative electrode 112 is pressed, such as by rolling a roll press across the active layer 112a. The pressing step 210 may smooth cracks and ridges in the coated material to produce a smooth, even surface. The first drying step 208 described above is a moderate temperature drying step to limit cracking of the active layer 112a. If the first drying step 208 is conducted at a higher temperature instead, such as a temperature of about 80° C., 90° C., or more, the active layer 112a may experience more cracking. Thus, the pressing step 210 may become more important as the temperature of the first drying step 208 increases.

Finally, in step 212 of method 200, the coated material is fully dried by subjecting negative electrode 112 to a second drying step. In an exemplary embodiment, the second drying step 212 is performed by placing negative electrode 112 in a vacuum furnace that is heated to a temperature of about 110° C. or more for about 2 days. In this embodiment, the second drying step 212 is performed at a higher temperature than the first drying step 208.

Returning to FIG. 1, positive electrode 114 of cell 100 illustratively includes a first layer 114a of an active material that interacts with lithium ions in electrolyte 116 and an underlying substrate or second layer 114b of a conductive material. Like the first, active layer 112a of negative electrode 112, the first, active layer 114a of positive electrode 114 may be applied to one or both sides of the second, conductive layer 114b using a suitable adhesive or binder. An exemplary active material for the first layer 114a of positive electrode 114 is LiNiCoMnO₂ (NMC), which is stable and has a high energy density. Other exemplary active materials for the first layer 114a of positive electrode 114 include metal oxides, such as LiMn₂O₄ (LMO), LiCoO₂ (LCO), LiNiO₂, LiFePO₄, and combinations thereof. Exemplary conductive materials for the second layer 114b of positive electrode 114 include metals and metal alloys, such as aluminum, titanium, and stainless steel. The second, conductive layer 114b of positive electrode 114 may be in the form of a thin foil sheet or a mesh, for example.

In an exemplary embodiment, water-based binder slurries similar to those described above for applying the active layer 112a to the conductive layer 112b of the negative electrode 112 may also be used to apply the active layer 114a to the conductive layer 114b of the positive electrode 114. Alternatively, an organic binder slurry, such as polyvinylidene fluoride (PVDF) dissolved in NMP, may be used to apply the active layer 114a to the conductive layer 114b of the positive electrode 114.

As shown in FIG. 1, negative electrode 112 and positive electrode 114 of cell 100 are plate-shaped structures. It is also within the scope of the present disclosure that negative electrode 112 and positive electrode 114 of cell 100 may be provided in other shapes or configurations, such as coiled configurations. It is further within the scope of the present disclosure that multiple negative electrodes 112 and positive electrodes 114 may be arranged together in a stacked configuration.

Electrolyte 116 of cell 100 illustratively includes a lithium salt dissolved in an organic, non-aqueous solvent. The solvent of electrolyte 116 may be in a liquid state, in a solid state, or in a gel form between the liquid and solid states. Suitable liquid solvents for use as electrolyte 116 include, for example, cyclic carbonates (e.g. propylene carbonate (PC), ethylene carbonate (EC)), alkyl carbonates, dialkyl carbonates (e.g., dimethyl carbonate (DMC), diethyl carbonate (DEC), ethyl methyl carbonate (EMC)), cyclic ethers, cyclic esters, glymes, lactones, formates, esters, sulfones, nitrates, oxazoladinones, and combinations thereof. Suitable solid solvents for use as electrolyte 116 include, for example, polyethylene oxide (PEO), polyacrylonitrile (PAN), polymethylene-polyethylene oxide (MPEO), polyvinylidene fluoride (PVDF), polyphosphazenes (PPE), and combinations thereof. Suitable lithium salts for use in electrolyte 116 include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiCF₃CO₂, LiAsF₆, LiSbF₆, and combinations thereof. Electrolyte 116 may comprise various combinations of the materials exemplified herein.

It is within the scope of the present disclosure to include one or more flame-retardant additives in electrolyte 116 of cell 100, as set forth in U.S. Provisional Patent Application Ser. No. 61/552,620, entitled “PERFORMANCE ENHANCEMENT ADDITIVES FOR DISORDERED CARBON ANODES,” filed Oct. 28, 2011, the disclosure of which is expressly incorporated herein by reference.

Separator 118 of cell 100 is illustratively positioned between negative electrode 112 and positive electrode 114 to prevent a short circuit within cell 100. Separator 118 may be in the form of a polyolefin membrane (e.g., a polyethylene membrane, a polypropylene membrane) or a ceramic membrane, for example.

### EXAMPLES

The following examples illustrate the impact of water-based binder slurries on lithium ion half cells and full cells. Unless otherwise indicated, the tested cells were bag-type cells and were charged and discharged at ambient temperature. The tested cells included 1.2 M LiPF₆ salt with 25 wt. % EC, 5 wt. % PC, and 70 wt. % EMC as the electrolyte. The tested cells also included either a Celgard® 2500 separator or a Celgard® A682 separator, both of which are commercially available from Celgard, LLC of Charlotte, N.C.

### 1-A. Example 1-A

### First Water-Based Binder Slurry with Hard Carbon Active Material

A first water-based binder slurry was produced with about 98 wt. % hard carbon active material, about 1 wt. % CMC, and about 1 wt. % SBR dissolved in distilled water. The hard carbon active material was Carbotron® Type S (F) Hard Carbon available from Kureha of New York, N.Y. The CMC was Cellogen® BSH-6 (2% CMC) available from Dai-Ichi Kogyo Seiyaku Co., Ltd. of Japan. The SBR was AY-9074 (40% SBR) available from Zeon Corporation of Japan. Together, the hard carbon, CMC, and SBR made up 49.9 wt. % of the binder slurry, with the distilled water making up the balance.

The materials were mixed in a 0.6 L planetary mixer for about 30 minutes. After mixing, the slurry was coated onto a 10 μm thick sheet of copper foil at an average coating weight of 8.5 mg/cm². The coated electrodes were placed in a vacuum oven at 110° C. for about three days to dry.

### 1-B. Example 1-B

### Half Cell Testing of First Water-Based Binder Slurry

The coated electrodes from Example 1-A were paired with lithium metal to make half cells, some of which lacked the J2 flame-retardant additive in the electrolyte and others of which included 6 wt. % of the J2 flame-retardant additive in the electrolyte.

The half cells were subjected to three cycles of formation testing in a battery testing apparatus available from Arbin Instruments of College Station, Tex. During each formation cycle, the half cells were charged at C/10 to 1.5 V. During the first formation cycle, the half cells were discharged at C/20 to 0.002 V. During the second and third formation cycles, the half cells were discharged at C/10 to 0.002 V, then held at constant voltage until 1 mA. The half cells were allowed to rest between charge and discharge for 10 minutes.

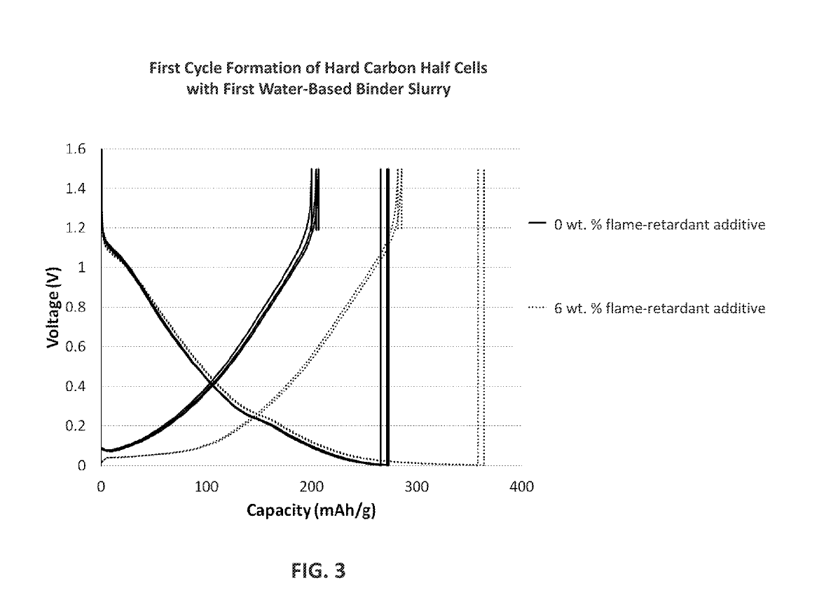

During the first formation cycle, the results of which are presented in FIG. 3, the reversible specific capacity of the hard carbon electrode reached as high as 207 mAh/g and the initial specific capacity of the hard carbon electrode reached as high as 273 mAh/g without the J2 flame-retardant additive. These capacity values increased with the J2 flame-retardant additive, the reversible specific capacity of the hard carbon electrode reaching as high as 285 mAh/g and the initial specific capacity of the hard carbon electrode reaching as high as 364 mAh/g. Especially with the J2 flame-retardant additive, these capacity values approach the theoretical maximum capacity of graphite (372 mAh/g).

Although the present inventor anticipated that water-based binder slurries would hinder or preclude operation of hard carbon electrodes, acceptable capacity values were reached in Example 1-B, indicating that water-based binder slurries may be suitable for use with hard carbon electrodes.

### 1-C. Example 1-C

### Full Cell Testing of First Water-Based Binder Slurry

Other hard carbon electrodes from Example 1-A were paired with NMC electrodes to make full cells, some of which lacked the J2 flame-retardant additive in the electrolyte and others of which included 6 wt. % of the J2 flame-retardant additive in the electrolyte. The hard carbon electrodes had an average coating weight of 8.5 mg/cm² per side, and the NMC electrodes had an average coating weight of 15.1 mg/cm² per side, resulting in a N/P Ratio of 1.385 and a full cell capacity around 25.4 mAh.

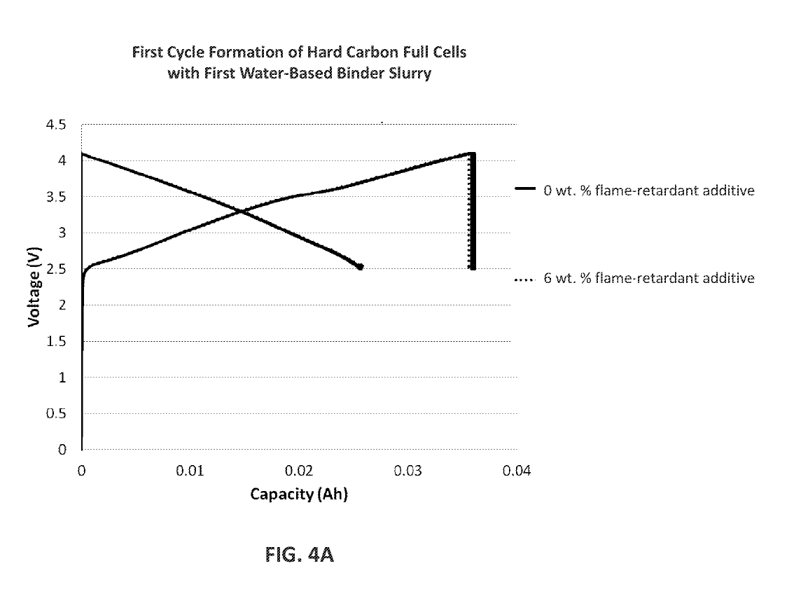

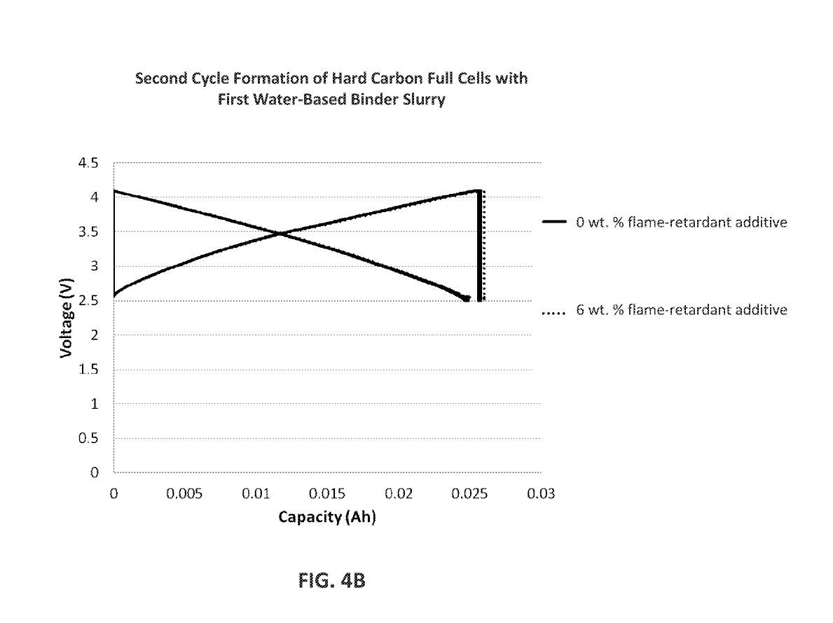

During formation testing, the full cells were charged at C/10 to 4.1 V, then at constant voltage of 4.1 V for 1 hour, and were discharged at C/10 to 2.5 V for three cycles. The full cells were allowed to rest between charge and discharge for 10 minutes. The first and second formation cycle results are presented in FIGS. 4A and 4B, respectively.

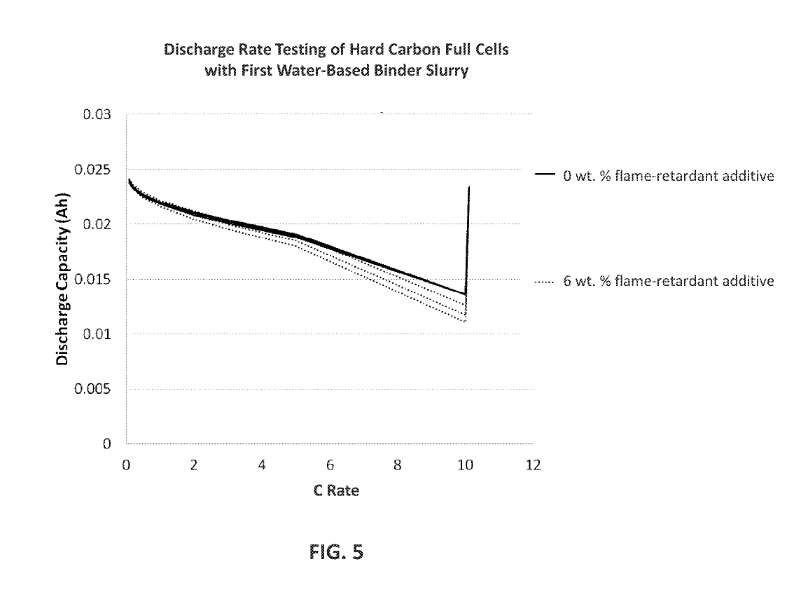

During discharge rate testing, the full cells were charged at C/2 to 4.1 V, then at constant voltage of 4.1 V for 1 hour, and were discharged at various rates to 2.5 V. The full cells were allowed to rest between charge and discharge for 10 minutes. The full cells were also subjected to a C/10 recovery step to evaluate potential degradation. The discharge rate testing results are presented in FIG. 5.

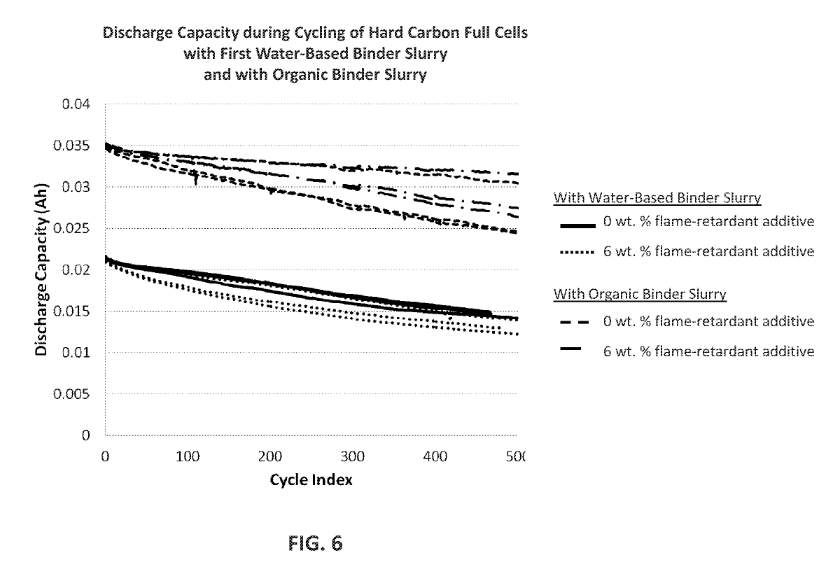

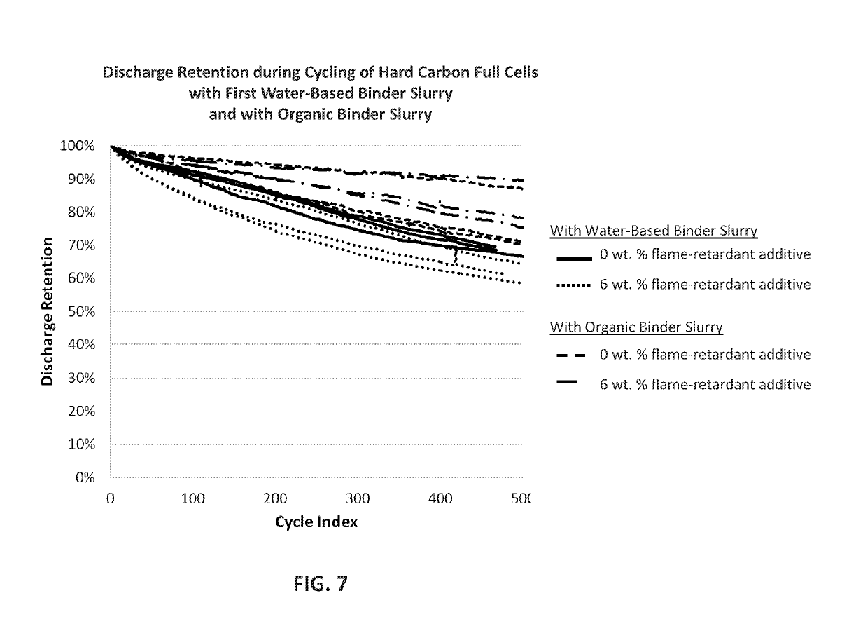

During cycle testing, the full cells were charged at 1C to 4.1 V, then at constant voltage of 4.1 V for 1 hour, and were discharged at 1C to 2.5 V. The full cells were allowed to rest between charge and discharge for 10 minutes. The cycling results are presented in FIGS. 6 and 7. For comparison, FIGS. 6 and 7 also include (in phantom) the cycling results of full cells having hard carbon electrodes coated with standard, organic binder slurries of PVDF and NMP. The present inventor anticipated that water-based binder slurries would hinder or preclude operation of hard carbon electrodes. Although the water-based binder cells performed slightly worse than the organic binder cells, the water-based binder cells still exhibited satisfactory discharge retention (FIG. 7).

The J2 flame-retardant additive had a more significant impact on the half cell results of Example 1-B than the full cell results of Example 1-C. In FIGS. 4A and 4B, for example, there is virtually no difference in formation capacity with and without the J2 flame-retardant additive.

### 2-A. Example 2-A

### Second Water-Based Binder Slurry with Hard Carbon Active Material

A second water-based binder slurry was produced with about 96 wt. % hard carbon active material, about 2 wt. % CMC, and about 2 wt. % SBR dissolved in distilled water. Compared to the first water-based binder slurry of Example 1-A, the second water-based binder slurry included more binder materials and exhibited better adhesion.

Mixing Day (Day 1): Other than the relative amounts of the active material, CMC, and SBR, the second water-based binder slurry was prepared in accordance with Example 1-A. The binder slurry was too viscous on Day 1, but was left to sit until Day 2 due to time constraints.

First Coating Day (Day 2): The binder slurry was noticeably thicker on Day 2 compared to Day 1. About 10 g of additional water was added to decrease the viscosity. The binder slurry was returned to the 0.6 L planetary mixer and was mixed for about 1 hour at 40 rpm to reach a suitable viscosity. Samples of the binder slurry were coated onto 10 μm thick sheets of copper foil on Day 2 and dried, and the remaining binder slurry was left in the planetary mixer.

Second Coating Day (Day 6): The binder slurry was again mixed for about 1 hour in the 0.6 L planetary mixer at 40 rpm to reach a suitable viscosity. Unlike Day 2, no additional water was needed to decrease the bulk viscosity of the binder slurry. However, there was noticeable hardened material on the sides of the mixer and mixing blades. Samples of the binder slurry were coated onto 10 μm thick sheets of copper foil on Day 6 and dried, and the remaining binder slurry was left in the planetary mixer.

Third Coating Day (Day 8): The binder slurry was once again mixed for about 1 hour in the 0.6 L planetary mixer at 40 rpm to reach a suitable viscosity. No additional water was needed to decrease the bulk viscosity of the binder slurry. However, there was again noticeable hardened material on the sides of the mixer and mixing blades. Samples of the binder slurry were coated onto 10 μm thick sheets of copper foil on Day 8 and dried, and the remaining binder slurry was discarded.

### 2-B. Example 2-B

### Half Cell Testing of Second Water-Based Binder Slurry

The Day 2, Day 6, and Day 8 electrodes from Example 2-A were paired with lithium metal to make half cells, some of which lacked the J2 flame-retardant additive in the electrolyte and others of which included 6 wt. % of the J2 flame-retardant additive in the electrolyte.

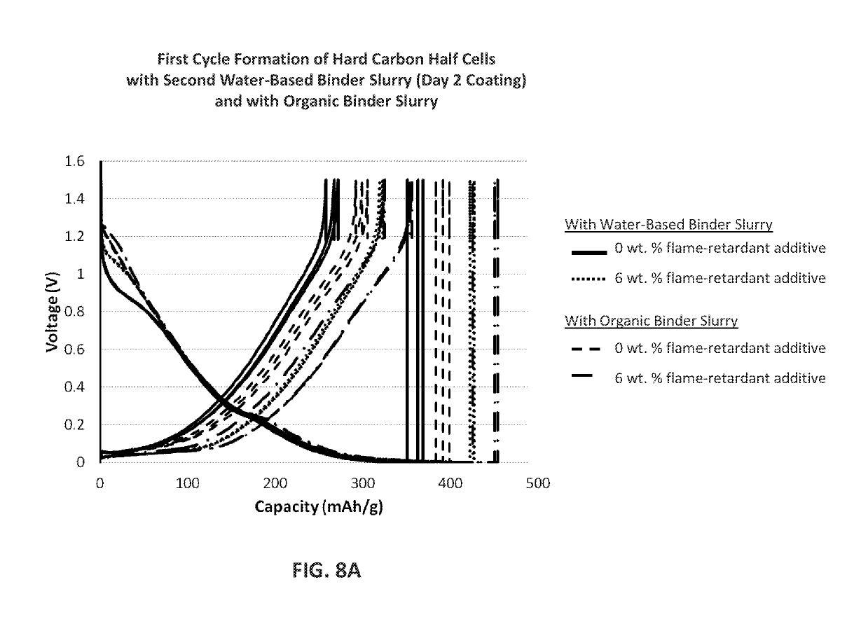

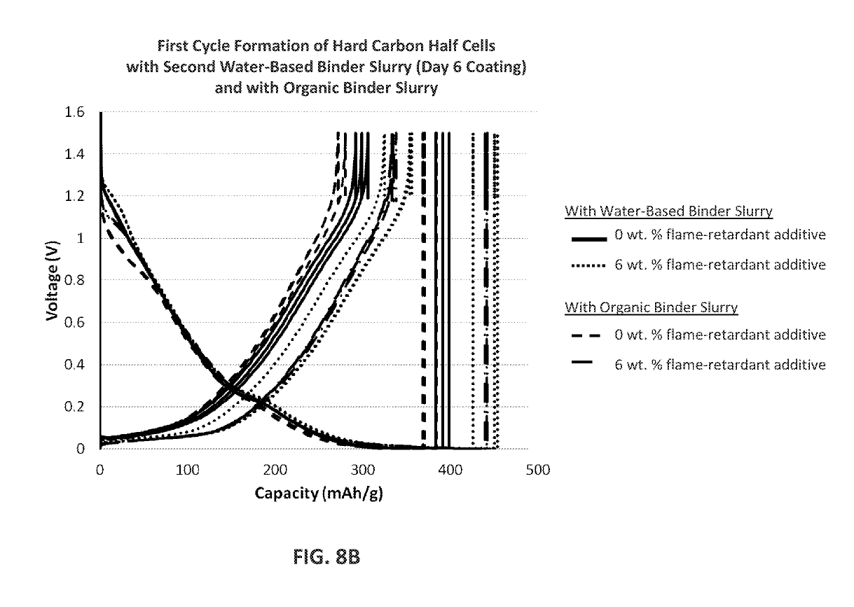

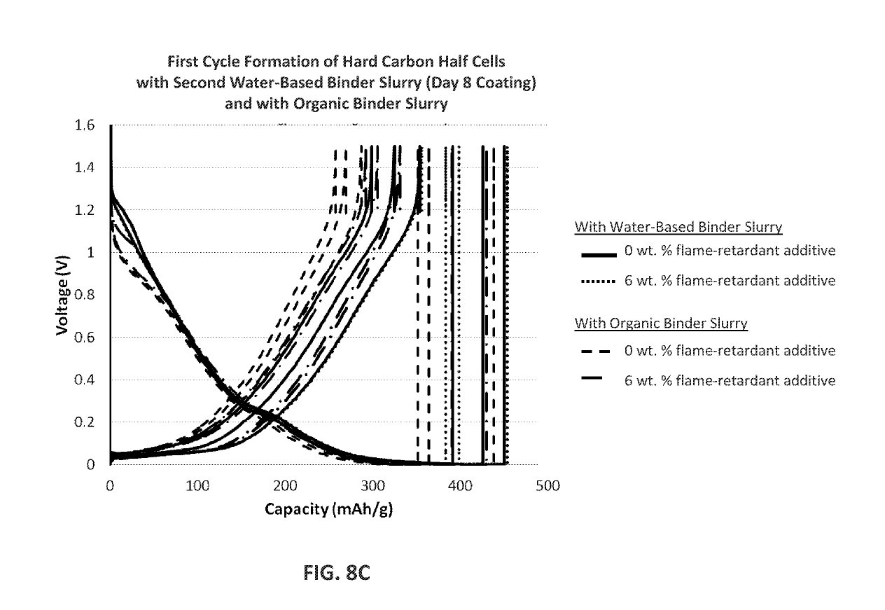

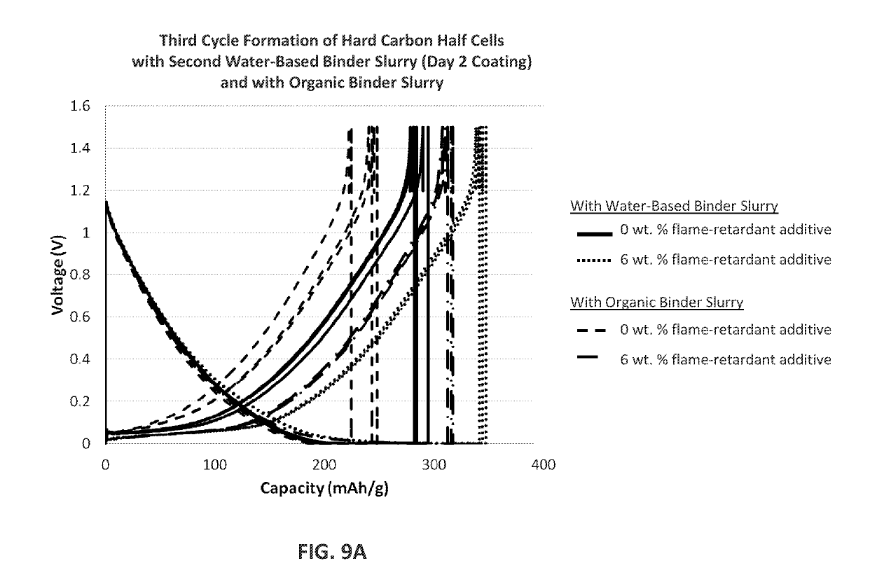

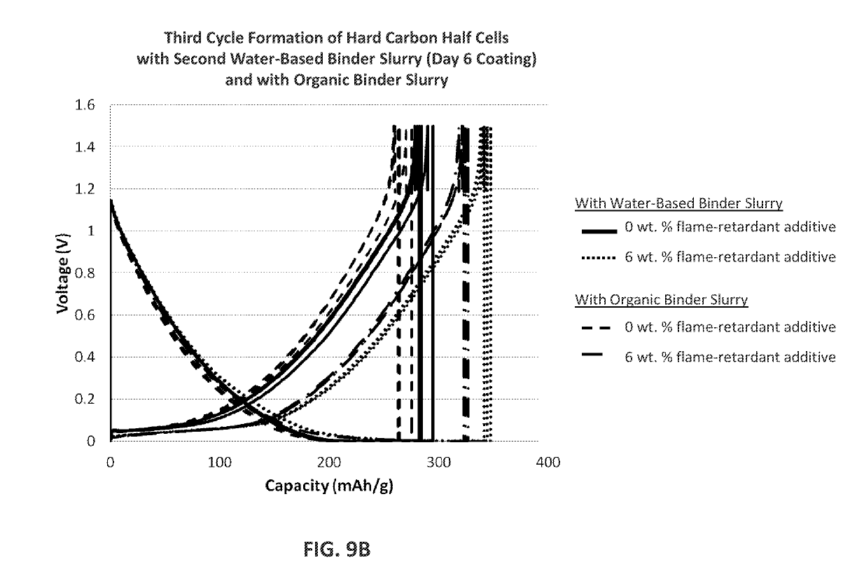

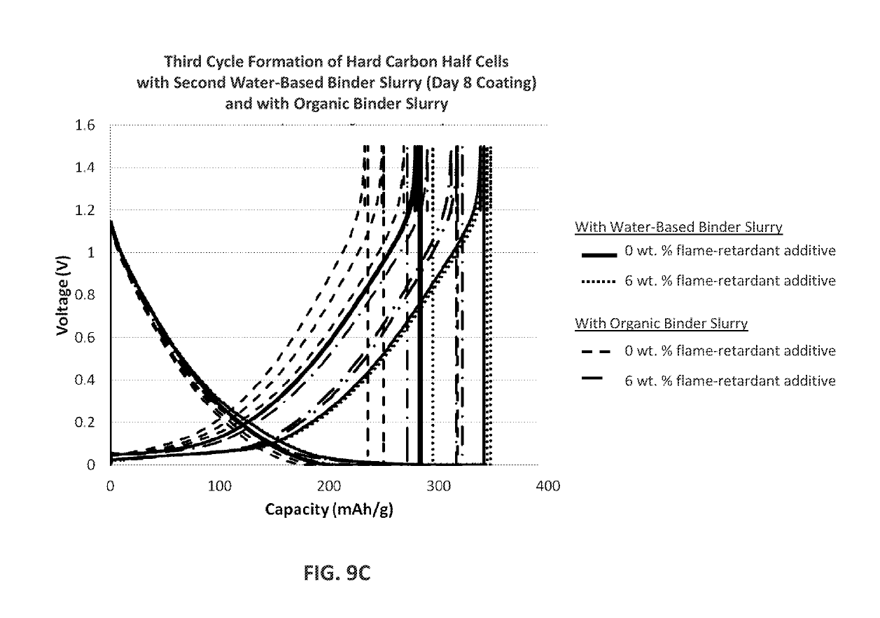

During formation testing, the half cells were charged at C/10 to 1.5 V and were discharged at C/20 to 0.002 V, then at constant voltage until 1 mA for three cycles. The first cycle formation results are presented in FIGS. 8A-8C and the third cycle formation results are presented in FIGS. 9A-9C. The formation capacity results are quite consistent between the Day 2, Day 6, and Day 8 samples, which indicates stability of the water-based hard carbon binder slurry.

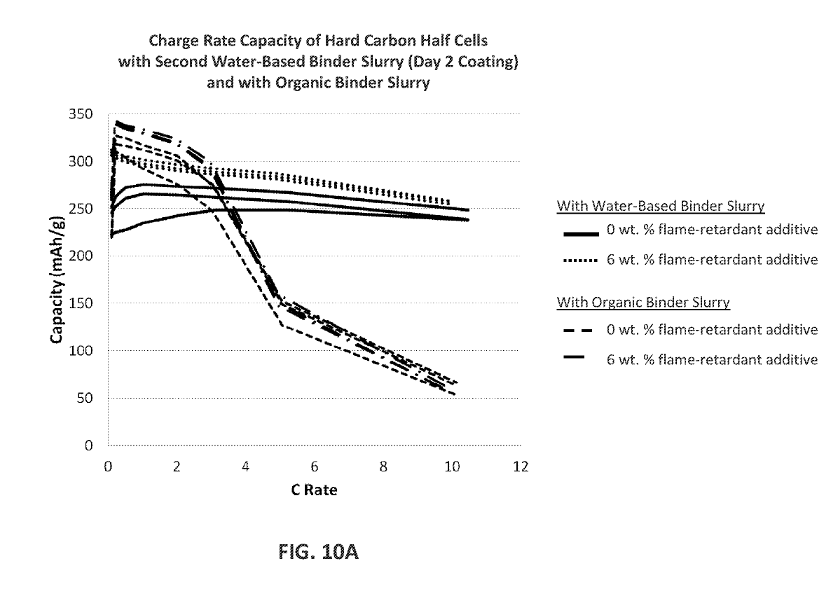

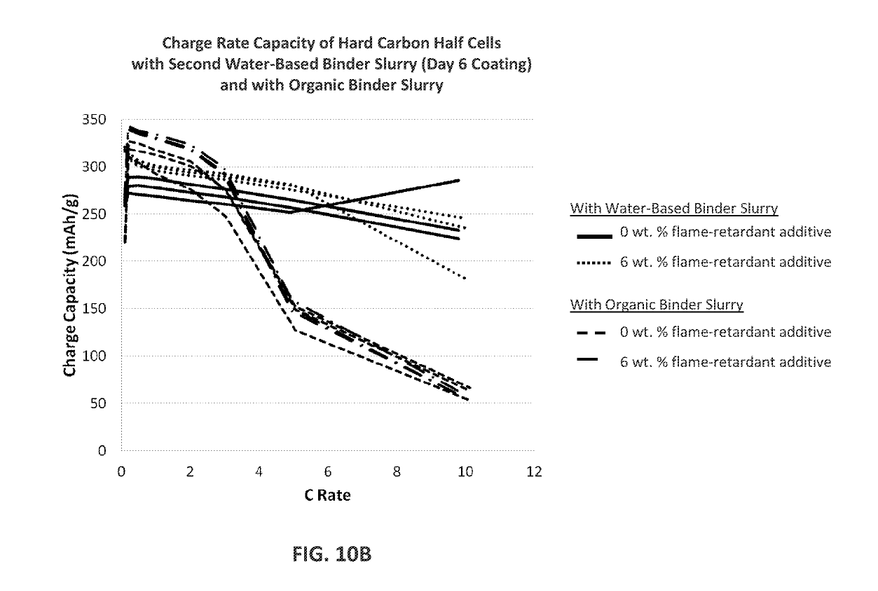

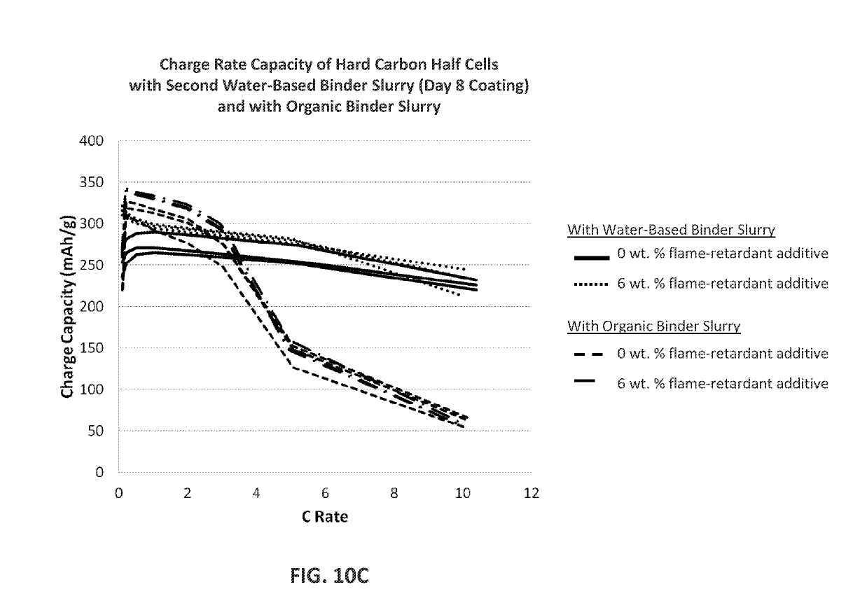

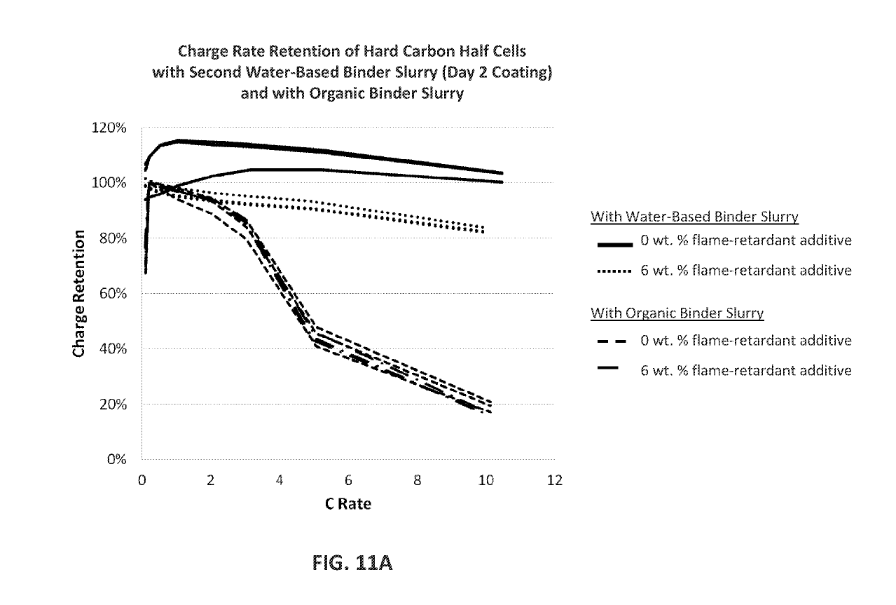

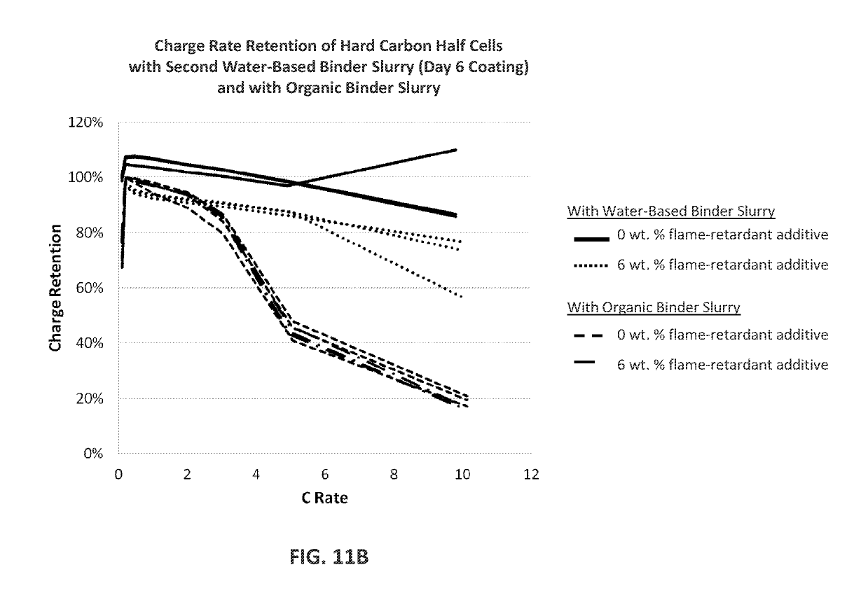

During charge rate testing, the half cells were charged at various rates to 1.5 V and were discharged at C/2 to 0.002 V, then at constant voltage until 1 mA. The charge rate capacity results are presented in FIGS. 10A-10C, and the charge rate retention results are presented in FIGS. 11A-11C. The charge rate results are quite consistent between the Day 2, Day 6, and Day 8 samples, which again indicates stability of the water-based hard carbon binder slurry.

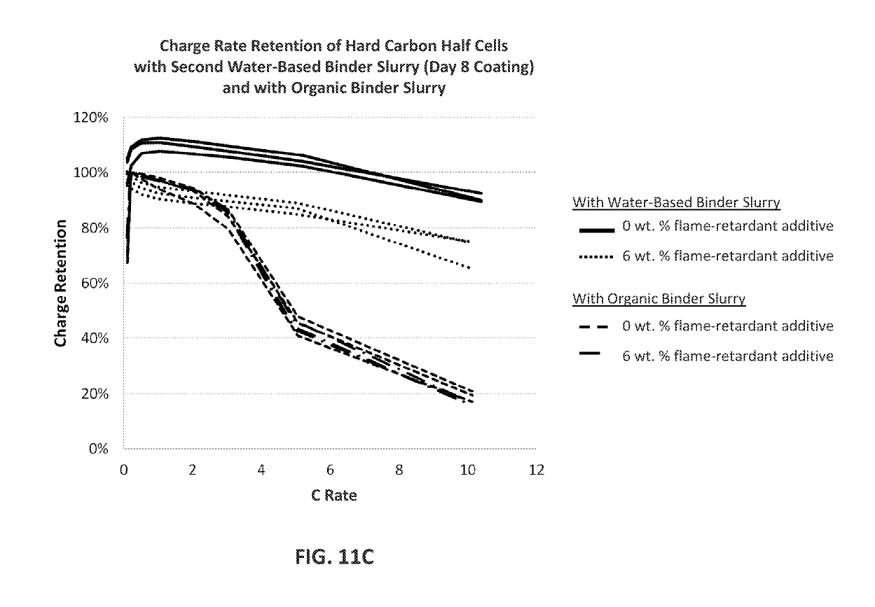

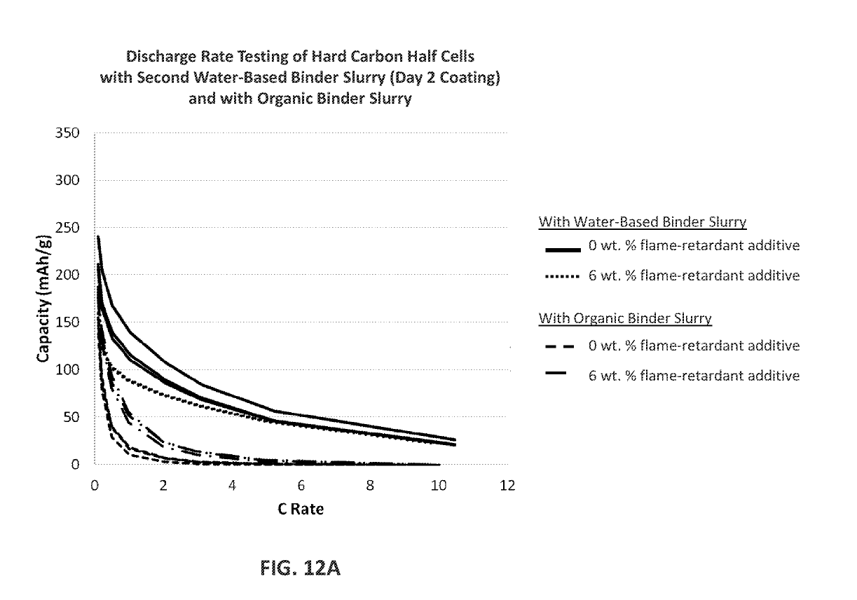

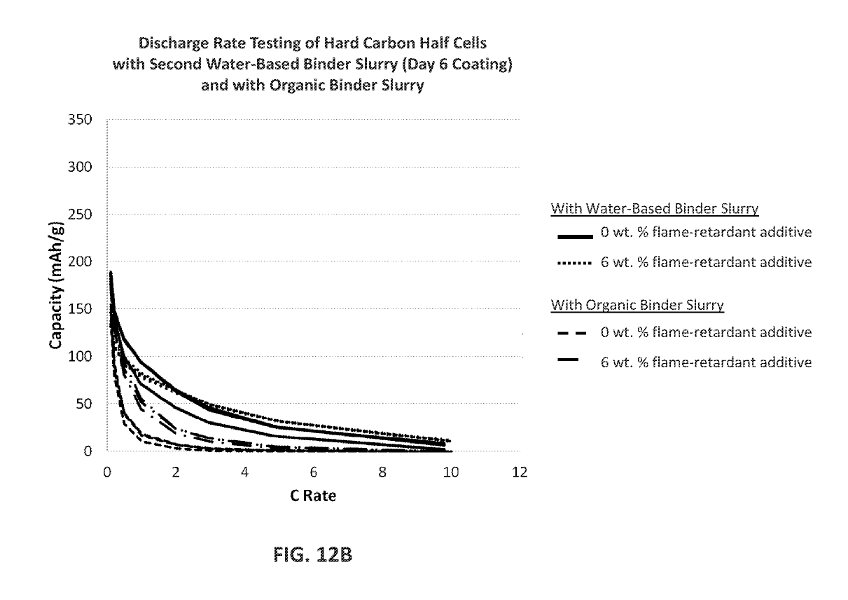

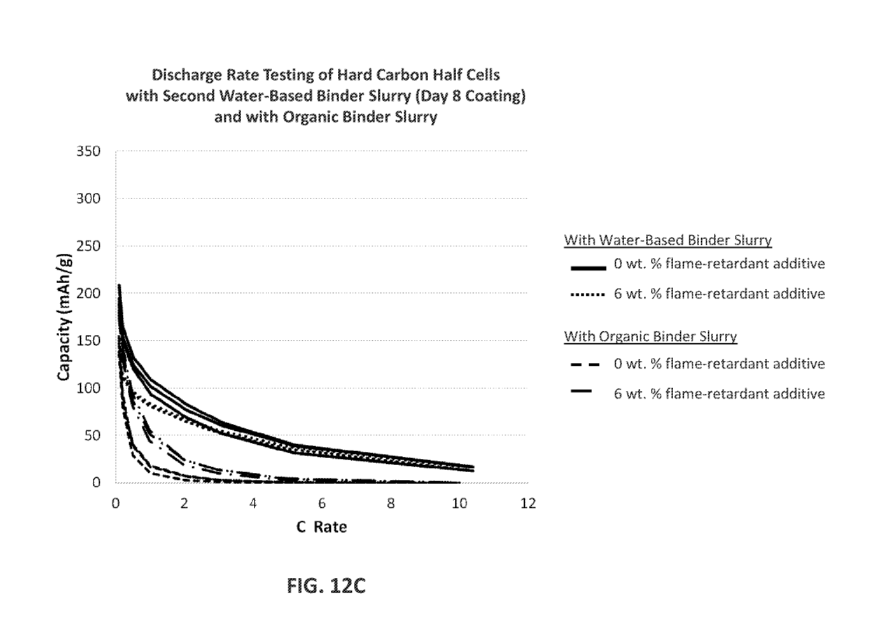

During discharge rate testing, the half cells were charged at C/2 to 1.5 V and were discharged at various rates to 2 mV. The discharge rate testing results are presented in FIGS. 12A-12C. The discharge rate results are quite consistent between the Day 2, Day 6, and Day 8 samples, which once again indicates stability of the water-based hard carbon binder slurry.

For comparison, FIGS. 8A-12C also include (in phantom) the test results of half cells having hard carbon electrodes coated with standard, organic binder slurries of PVDF and NMP. Although the present inventor anticipated that water-based binder slurries would hinder or preclude operation of hard carbon electrodes, Example 2-B demonstrates otherwise. Although the water-based binder half cells had slightly lower formation capacities than the organic binder half cells (FIGS. 8A-8C and 9A-9C), the water-based binder half cells exhibited better rate performance than the organic binder half cells (FIGS. 10A-10C, 11A-11C, and 12A-12C).

### 2-C. Example 2-C

### Full Cell Testing of Second Water-Based Binder Slurry

The Day 6 electrodes from Example 2-A were also paired with NMC electrodes to make full cells, some of which lacked the J2 flame-retardant additive in the electrolyte and others of which included 6 wt. % of the J2 flame-retardant additive in the electrolyte. The hard carbon electrodes had an average coating weight of 7.0 mg/cm² per side, and the NMC electrodes had an average coating weight of 15.1 mg/cm² per side, resulting in a N/P Ratio of 1.31 and a full cell capacity of 27.5 mAh. At this N/P ratio of 1.31, there is more negative potential available in the hard carbon electrode (anode) than positive potential available in the NMC electrode (cathode). Therefore, the NMC electrode should run out of capacity before the voltage of the hard carbon electrode drops too low (e.g., below 0 V (relative to a lithium reference), which should avoid lithium dendrite formation.

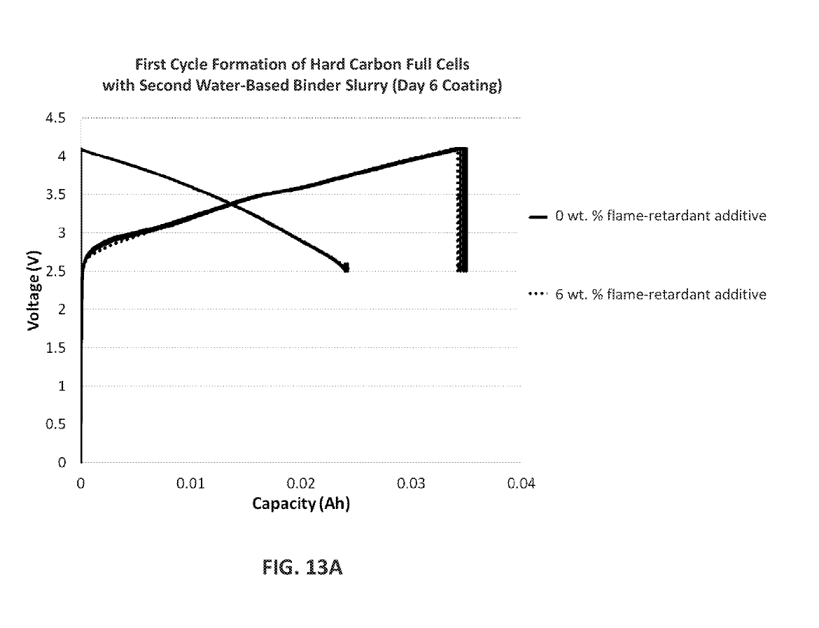

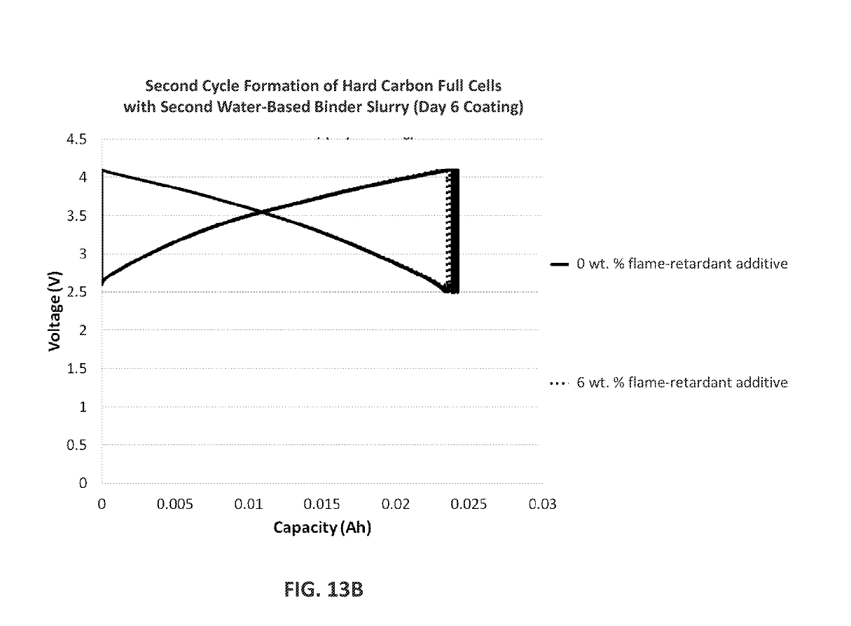

During formation testing, the full cells were charged at C/10 to 4.1 V, then at constant voltage of 4.2 V for 1 hour, and were discharged at C/10 to 2.5 V. The first and second formation cycle results are presented in FIGS. 13A and 13B, respectively.

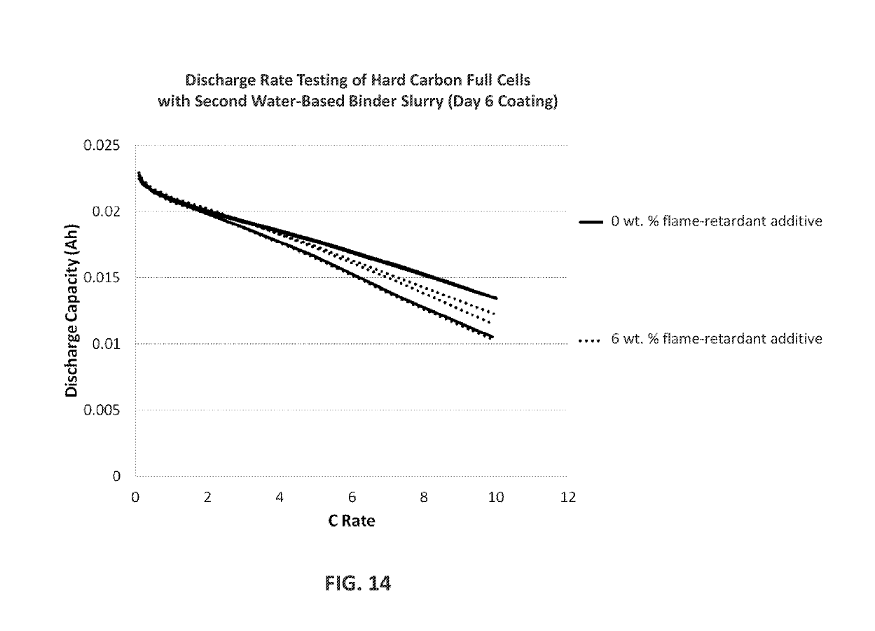

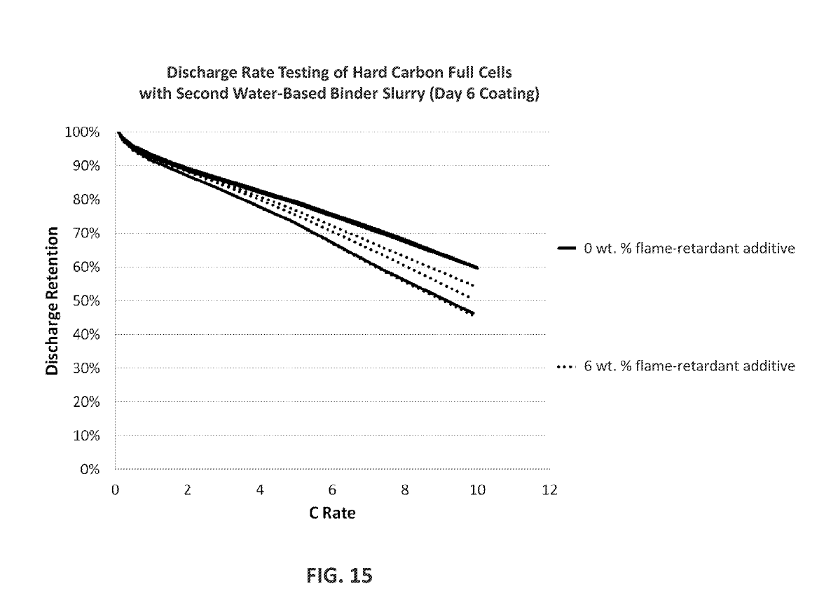

During discharge rate testing, the full cells were charged at C/2 to 4.1 V, then at constant voltage of 4.1 V for 1 hour, and were discharged at various rates to 2.5 V. The discharge rate testing results are presented in FIG. 14 and FIG. 15.

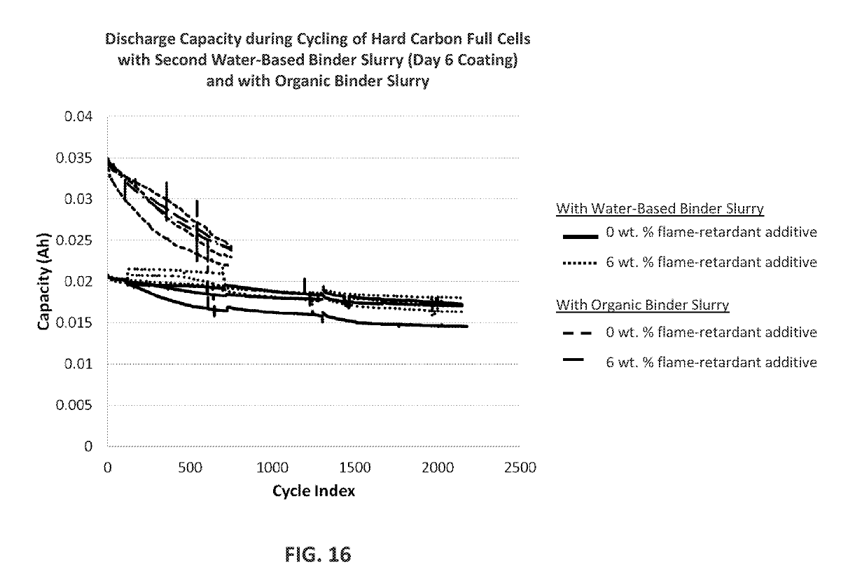

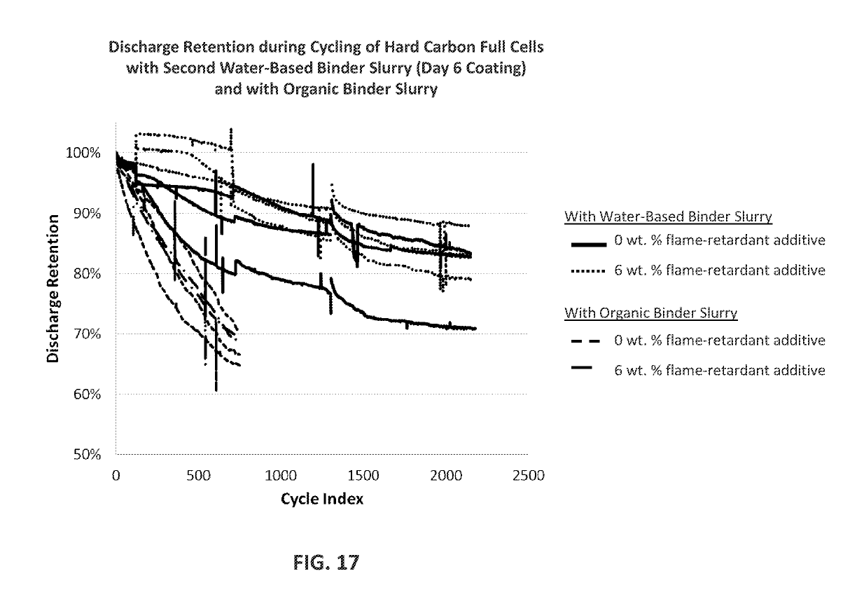

During cycle testing, the full cells were charged at 1C to 4.1 V, then at constant voltage of 4.1 V for 1 hour, and were discharged at 1C to 2.5 V. The cycling results are presented in FIGS. 16 and 17. Even after 800 cycles, the cells retained about 90% of their charge (FIG. 17). For comparison, FIGS. 16 and 17 also include (in phantom) the cycling results of full cells having hard carbon electrodes coated with standard, organic binder slurries of PVDF and NMP and a N/P ratio of 1.08. The water-based binder cells exhibited better discharge retention than the organic binder cells (FIG. 17). This result may be attributed, in part, to the fact that the water-based binder cells had more desirable N/P ratios than the organic binder cells.

The J2 flame-retardant additive noticeably improved cycling performance in FIGS. 16 and 17.

The inventor attributes the spike in the data between 100 and 700 cycles of FIGS. 16 and 17 to a calibration error.

### 3-A. Example 3-A

### Third Water-Based Binder Slurry with Hard Carbon Active Material

A third water-based binder slurry was produced with about 96 wt. % hard carbon active material, about 2 wt. % CMC, and about 2 wt. % SBR dissolved in distilled water. Unlike the first and second water-based binder slurries, which used Cellogen® BSH-6 from Dai-Ichi Kogyo Seiyaku Co., Ltd. of Japan as the CMC, the third water-based binder slurry used Sunrose® MAC350HC from Nippon Paper Chemicals Co., Ltd. as the CMC. The third water-based binder slurry was otherwise prepared and coated in accordance with Example 1-A.

The new, MAC350HC CMC material had been shown to improve the performance of graphite electrodes. According to manufacturer data, the degree of carboxymethyl-substitution is 0.65 to 0.75 for the BSH-6 CMC material and is 0.85 for the new, MAC350HC CMC material. The inventor hypothesized that the higher degree of substitution in the new, MAC350HC CMC material produced better contact and, therefore, better performance with graphite electrodes, and the inventor anticipated similar results with the hard carbon electrodes.

### 3-B. Example 3-B

### Half Cell Testing of Third Water-Based Binder Slurry

The hard carbon electrodes from Example 3-A were paired with lithium metal to make half cells, some of which lacked the J2 flame-retardant additive in the electrolyte and others of which included 6 wt. % of the J2 flame-retardant additive in the electrolyte.

During formation testing, the half cells were charged at C/10 to 1.5 V and were discharged at C/20 to 0.002 V, then at constant voltage until 1 mA. The results were similar to those presented in FIGS. 8A-9C, with the flame-retardant additive noticeably improving capacity in formation.

During charge rate testing, the half cells were charged at various rates to 1.5 V and were discharged at C/2 to 0.002 V, then at constant voltage until 1 mA. Compared to hard carbon electrodes coated with standard, organic binder slurries of PVDF and NMP, the hard carbon electrodes of Example 3-A that were coated with water-based binder slurries performed worse in capacity and retention at lower charge rates (e.g., C Rates below 4). However, the water-based binder half cells performed better in capacity and retention at higher charge rates (e.g., C Rates above 4), especially in the presence of the flame-retardant additive.

### 3-C. Example 3-C

### Full Cell Testing of Third Water-Based Binder Slurry

The hard carbon electrodes from Example 3-A were paired with NMC electrodes to make full cells, some of which lacked the J2 flame-retardant additive in the electrolyte and others of which included 6 wt. % of the J2 flame-retardant additive in the electrolyte. The hard carbon electrodes had an average coating weight of 10.0 mg/cm² per side, and the NMC electrodes had an average coating weight of 21.0 mg/cm² per side, resulting in a N/P Ratio of 1.18 and a full cell capacity around 43.7 mAh.

The full cells were subjected to formation testing and discharge rate testing and performed well, even compared to full cells having hard carbon electrodes coated with standard, organic binder slurries of PVDF and NMP.

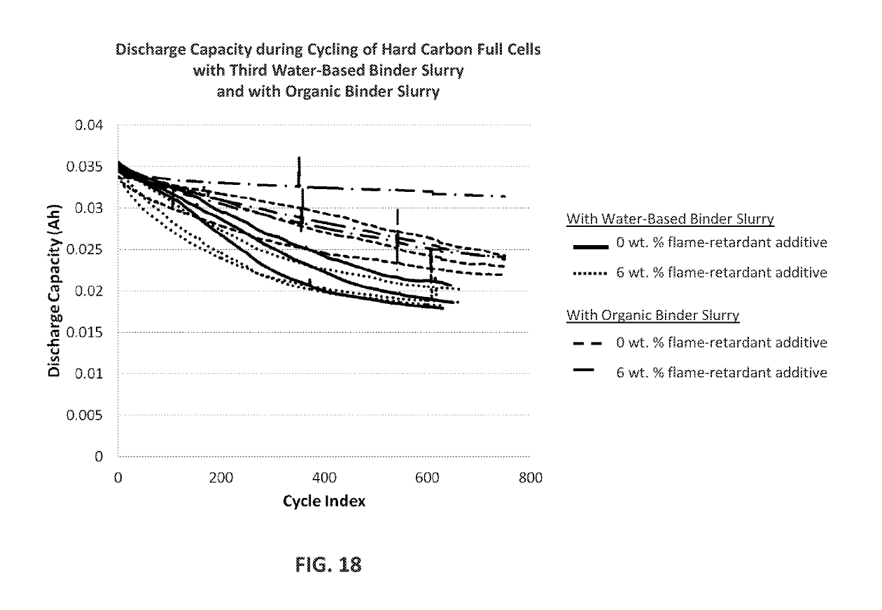

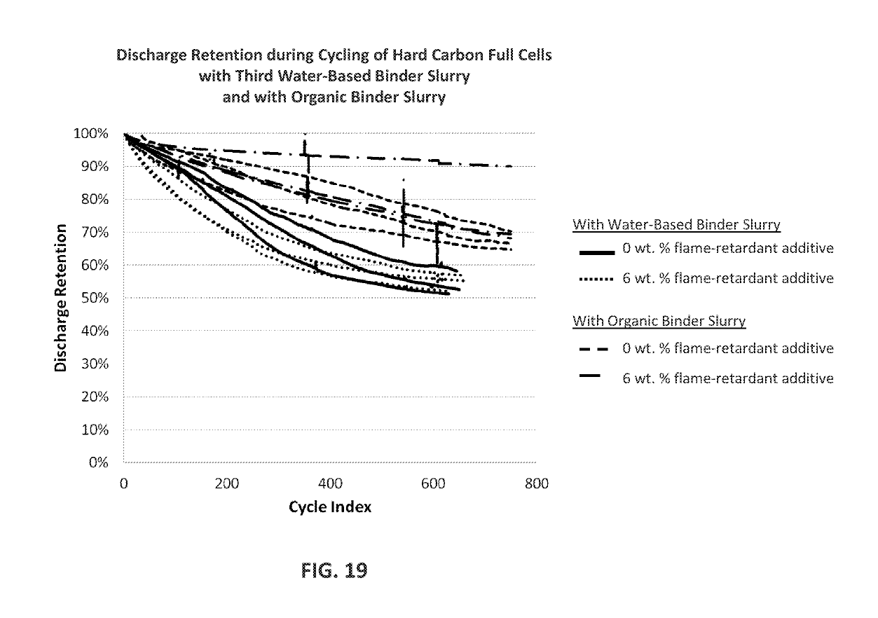

The full cells were also subjected to cycle testing, during which the full cells were charged at 1C to 4.1 V, then at constant voltage of 4.1 V for 1 hour, and were discharged at 1C to 2.5 V. The cycling results are presented in FIGS. 18 and 19. For comparison, FIGS. 18 and 19 also include (in phantom) the cycling results of full cells having hard carbon electrodes coated with organic binder slurries. Although the present inventor expected the more-highly-substituted MAC350HC CMC material in the water-based binder slurry to improve cell performance, these cells degraded quickly during cycling. By contrast, the full cells of Example 2-C having the less-substituted BSH-6 CMC material exhibited good cycling performance (FIG. 17).

### 4. Example 4

### Additional Half Cell and Full Cell Testing of Second Water-Based Binder Slurry

A new batch of the second water-based binder slurry from Example 2-A was produced with about 96 wt. % hard carbon active material, about 2 wt. % CMC, and about 2 wt. % SBR dissolved in distilled water. In Example 2-A, the second water-based binder slurry was applied at an average coating weight of 7.0 mg/cm² per side. In the present Example 4, the second water-based binder slurry was applied at a higher average coating weight of 10.0 mg/cm² per side.

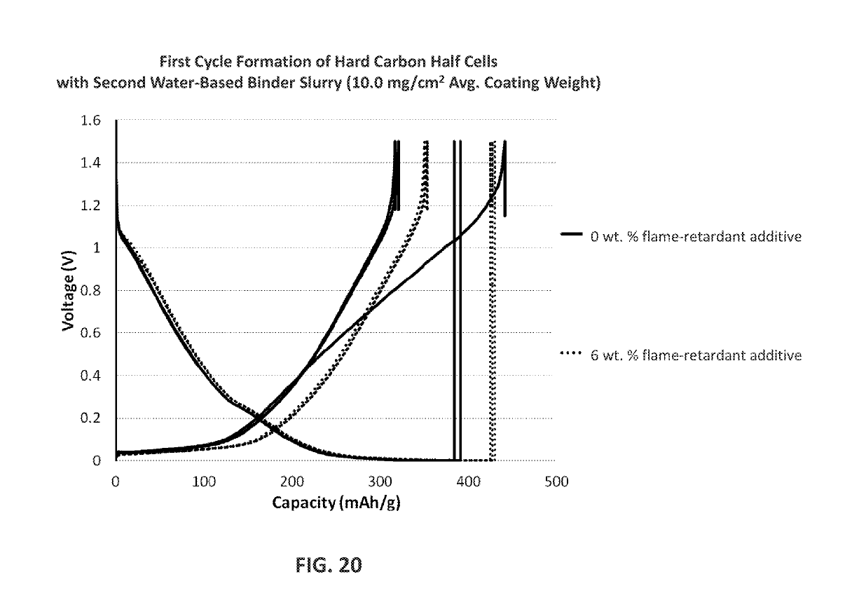

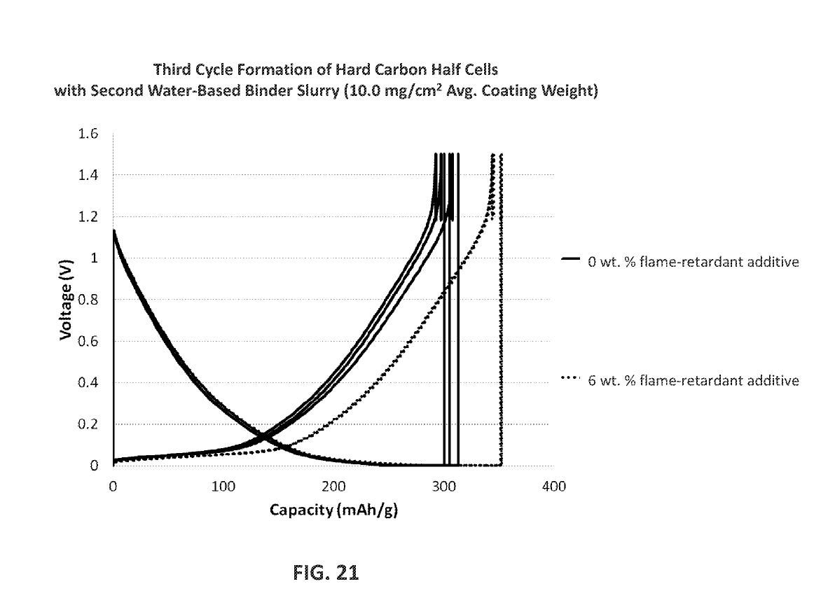

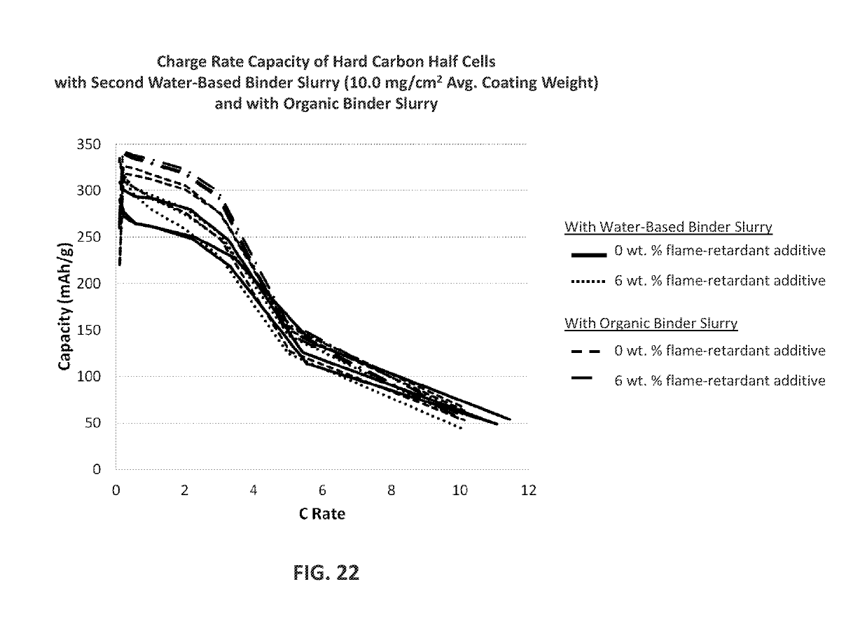

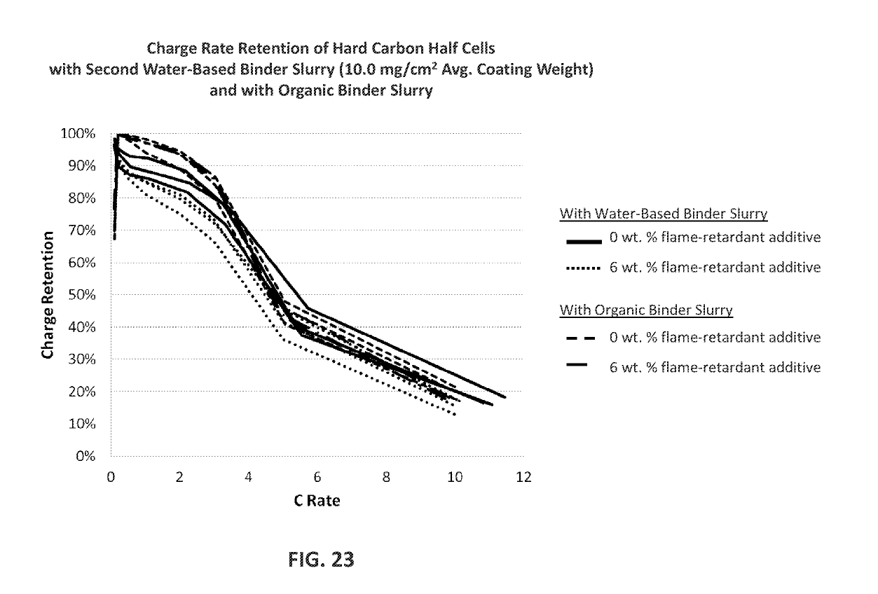

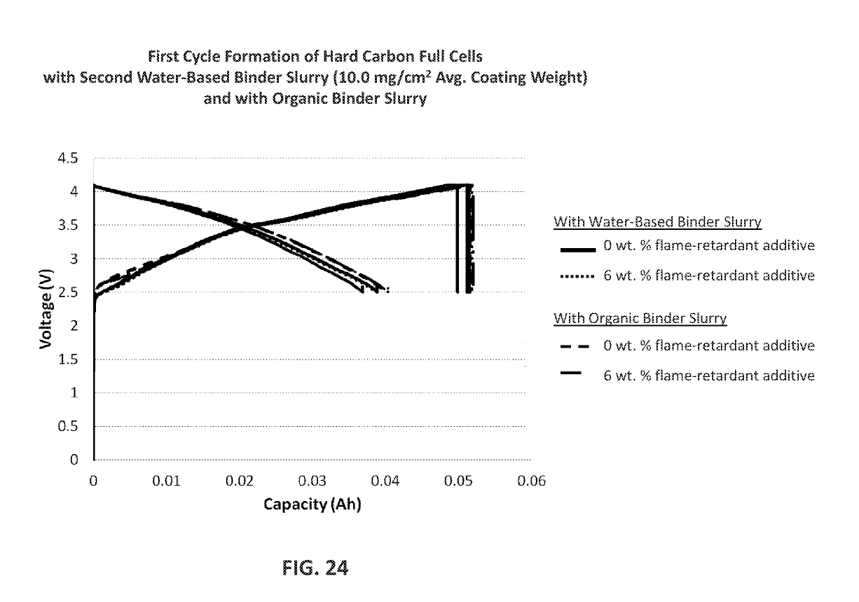

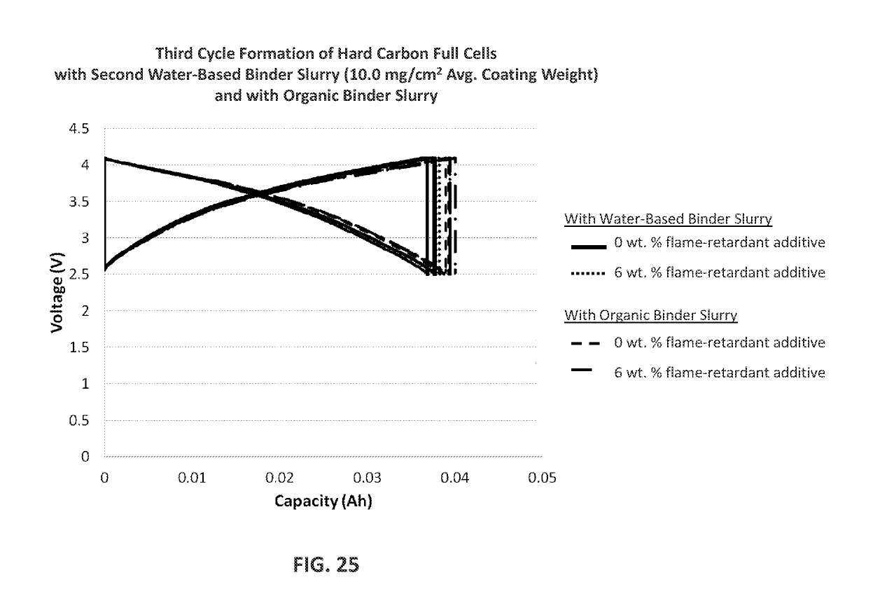

Half cells and full cells were prepared using these hard carbon electrodes, and the cells were subjected to the same testing as in Examples 2-B and 2-C. The results are presented in FIGS. 20-29. For comparison, some of these figures also include (in phantom) test results of cells having hard carbon electrodes coated with standard, organic binder slurries of PVDF and NMP. In this example, the electrode coating weights between the water-based binder cells and the organic binder cells were the same.

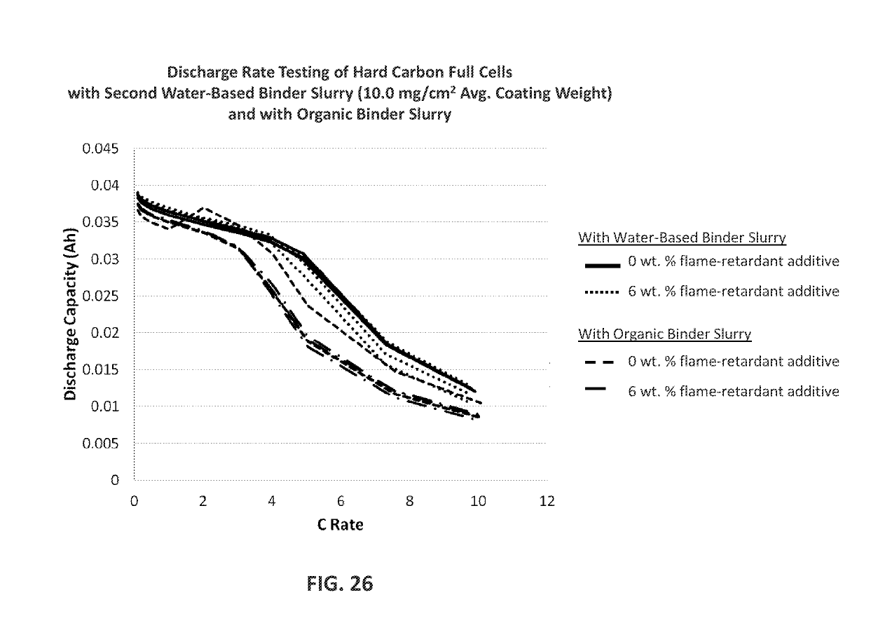

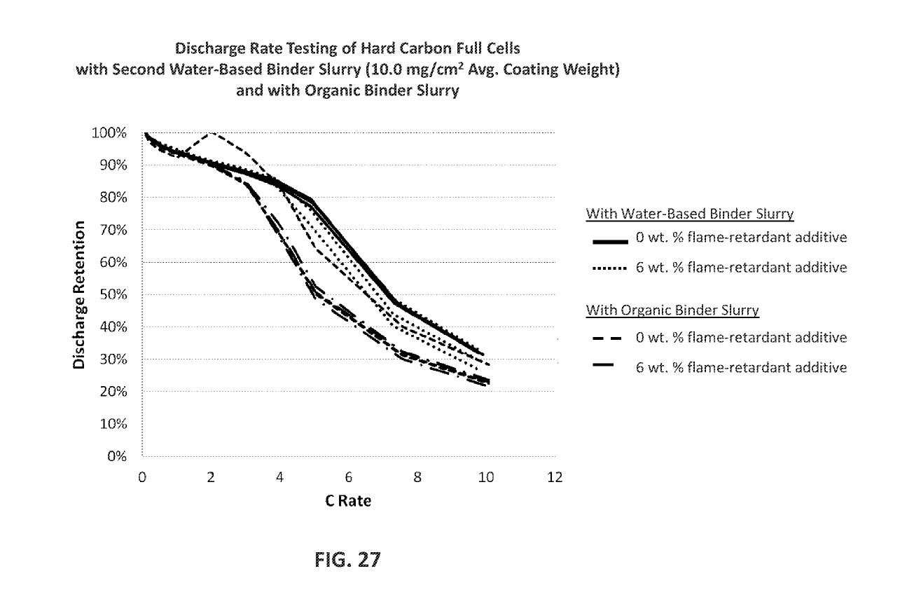

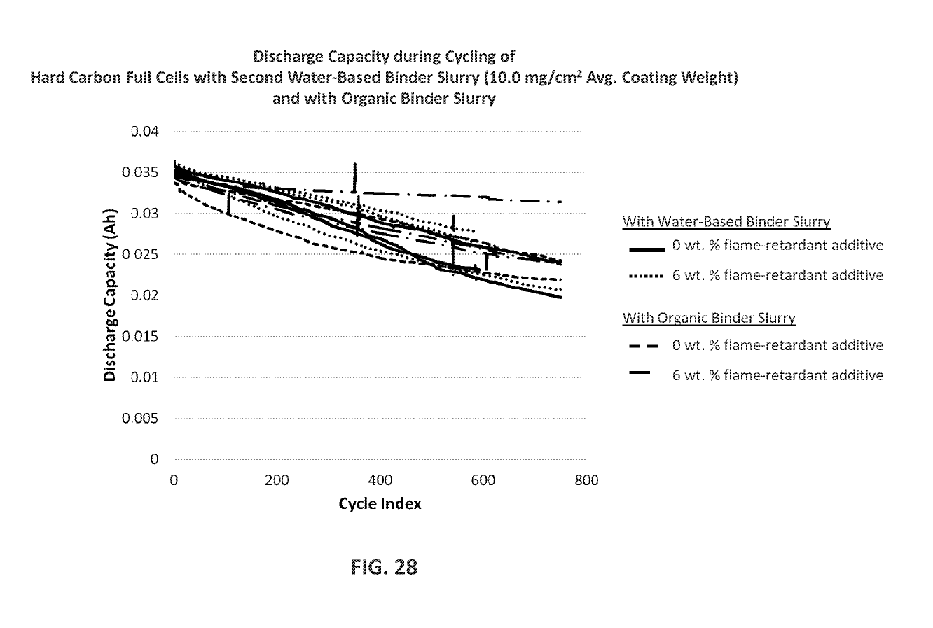

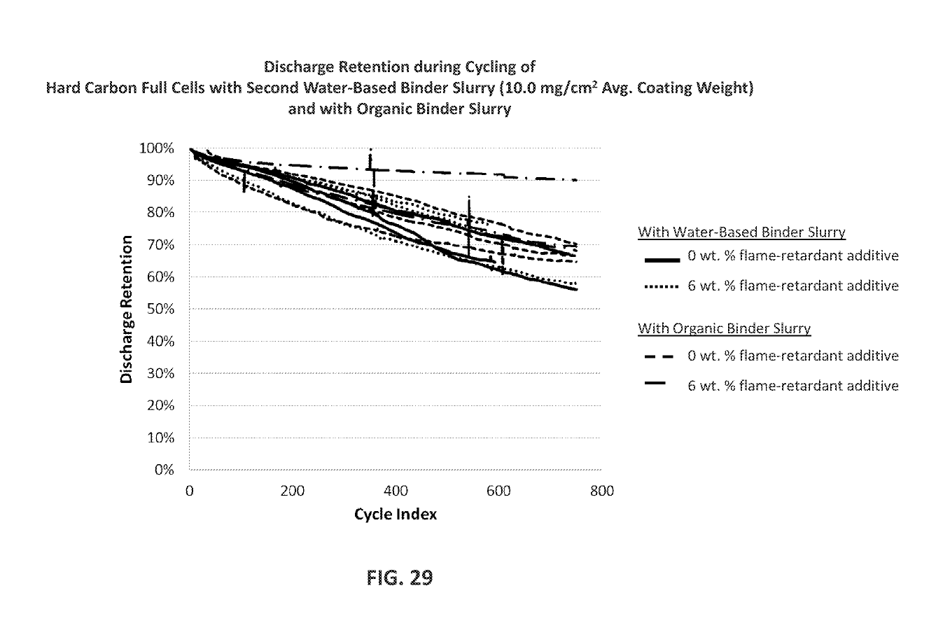

In general, increasing cell capacity negatively impacts cell performance during cycling. In this case, even after increasing the coating weight to improve capacity compared to Examples 2-B and 2-C, the water-based binder cells still performed about the same during cycling as the organic binder cells (FIGS. 28 and 29). Also, the water-based binder cells performed better during discharge rate testing than the organic binder cells (FIGS. 26 and 27).

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A water-based binder slurry used to produce an electrode of an electrochemical cell, the binder slurry comprising:
at least one disordered carbon material;
at least one binder; and
water.

2. The binder slurry of claim 1, wherein the at least one binder comprises carboxymethyl cellulose (CMC) and styrene butadiene rubber (SBR).

3. The binder slurry of claim 2, wherein the at least one disordered carbon material is present in the water at about 96 wt. %, the CMC is present in the water at about 2 wt. %, and the SBR is present in the water at about 2 wt. %.

4. The binder slurry of claim 2, wherein the at least one disordered carbon material, the CMC, and the SBR, together, comprise between about 40 wt. % and 60 wt. % of the binder slurry, with the water making up the balance of the binder slurry.

5. The binder slurry of claim 2, wherein the binder slurry consists essentially of the at least one disordered carbon material, the CMC, the SBR, and the water.

6. The binder slurry of claim 2, wherein the CMC in the binder slurry has a degree of carboxymethyl-substitution less than 0.85.

7. The binder slurry of claim 2, wherein the CMC in the binder slurry has a degree of carboxymethyl-substitution of 0.65 to 0.75.

8. The binder slurry of claim 1, wherein the binder slurry has a viscosity at room temperature between about 4,500 cP and 5,500 cP.

9. The binder slurry of claim 1, wherein the at least one disordered carbon material comprises hard carbon.

10. The binder slurry of claim 1, wherein the at least one disordered carbon material comprises soft carbon.

11. An electrochemical cell comprising:
a cathode comprising an active layer and a conductive layer;
an anode comprising an active layer with at least one disordered carbon material and a conductive layer, the at least one disordered carbon material in the active layer of the anode being adhered to the conductive layer of the anode using a binder slurry that comprises:
carboxymethyl cellulose (CMC);
styrene butadiene rubber (SBR); and
water; and
an electrolyte in communication with the anode and the cathode.

12. The electrochemical cell of claim 11, wherein the active layer of the anode is applied to a first side of the conductive layer of the anode at more than about 5 mg/cm².

13. The electrochemical cell of claim 12, wherein the active layer of the anode is applied to the first side of the conductive layer of the anode at about 10 mg/cm².

14. The electrochemical cell of claim 12, wherein the active layer of the anode is applied to a second side of the conductive layer of the anode opposite the first side.

15. The electrochemical cell of claim 11, wherein the active layer of the cathode comprises LiNiCoMnO₂ (NMC).

16. A method of manufacturing an electrochemical cell, the method comprising the steps of:
preparing a binder slurry comprising:
at least one disordered carbon material;
carboxymethyl cellulose (CMC);
styrene butadiene rubber (SBR); and
water;
applying the binder slurry to a conductive substrate to form an anode; and
placing the anode in electrical communication with a cathode.

17. The method of claim 16, wherein the preparing step comprises mixing the slurry to arrive at a viscosity at room temperature between about 4,500 cP and 5,500 cP.

18. The method of claim 16, further comprising the step of partially drying the anode after the applying step by placing the anode in a furnace that is heated to a first temperature of about 70° C. or less.

19. The method of claim 18, further comprising the step of fully drying the anode after partially drying the anode by placing the anode in a furnace that is heated to a second temperature higher than the first temperature.

20. The method of claim 19, further comprising the step of pressing the anode after partially drying and before fully drying the anode.
